(19) United States
(12) Patent Application Publication
(10) Pub. No.: US 2010/0064147 A1
(43) Pub. Date: Mar. 11, 2010

(54) PROFILE DRIVEN ELECTRICAL COMPONENT COMMAND INTERFACE

(75) Inventors: David A. Boles, Austin, TX (US); Donovan M. Kolbly, Sunset Valley, TX (US)

Correspondence Address: Integral Wave Technologies, Inc.;c/o DeLizio Gilliam, PLLC, 15204 Mason Road, Suite 1000-312, Cypress, TX, 77433, US

(73) Assignee: Integral Wave Technologies, Inc., Austin, TX (US)

(21) Appl. No.: 12/206,411

(22) Filed: Sep. 8, 2008

(51) Int. Cl. G06F 1/26; G06F 13/42

(52) U.S. Cl. 713/300; 710/105

(57) ABSTRACT

A profile-driven electrical component command interface allows a system to handle commands across devices that implement a specification differently. The profile-driven electrical component command interface handles electrical component command invocations for different electrical components (e.g., temperature sensor, power converter, accelerometer, gyro, etc.). The profile-driven electrical component command interface determines if an electrical component targeted by a command invocation supports the invoked command according to a profile for the targeted electrical component. The profile-driven electrical component command interface then performs the invoked command in accordance with an implementation definition provided in the targeted electrical component profile.

### BACKGROUND

Embodiments of the inventive subject matter generally relate to the field of electrical component communication systems and software, and, more particularly, to a profile-driven electrical component communication mechanism.

Computer systems employ bus architectures that communicate with circuit boards and electrical components in accordance with communication protocols. For example, at the component level, the System Management Bus (SMBus) protocol defines a communication protocol for a two-wire bus architecture, based upon the Inter-Integrated Circuit (I²C) interface specification, that is used for system management communications with electrical components of computer systems. The Power Management Bus (PMBus) protocol defines a communications protocol for digital power management communications. The PMBus protocol enhances the communication capabilities with respect to electrical components of digital power subsystems, e.g., power converters.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example conceptual diagram of a profile-driven electrical component command interface processing electrical component commands.

FIG. 2 depicts an example flow diagram of example operations for implementation definition agnostic electrical component command invocations.

FIG. 3 depicts a flow diagram of example operations for handling a read command.

FIG. 4 depicts a flow diagram of example operations for handling a write command.

FIG. 5 depicts an example computer system that implements profile-driven electrical component communication code.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to implementing profile-driven electrical component communication in systems according to the SMBus protocol and the PMBus protocol, in other embodiments profile-driven electrical component communication may be implemented in systems implementing other protocols (e.g., in accordance with the Smart Battery System specification). In other instances, well-known instruction instances, protocols, structures and techniques have not been shown in detail in order not to obfuscate the description.

Although protocol specifications (e.g., a PMBus specification) provide a framework for implementing a protocol, some specifications have loose implementation requirements. For instance, a specification may require a conforming device to implement a particular command without providing specific details about formatting for the command. Although greater flexibility can foster wider adoption of the specification, greater flexibility can also lead to a lack of uniformity and predictability across implementations of the specification. A profile-driven electrical component command interface allows a system to handle commands across devices that implement a specification differently. The profile-driven electrical component command interface handles electrical component command invocations for different electrical components (e.g., temperature sensor, power converter, accelerometer, gyros, etc.). The profile-driven electrical component command interface determines if an electrical component targeted by a command invocation supports the invoked command according to a profile for the targeted electrical component. The profile-driven electrical component command interface then performs the invoked command in accordance with an implementation definition provided in the targeted electrical component profile.

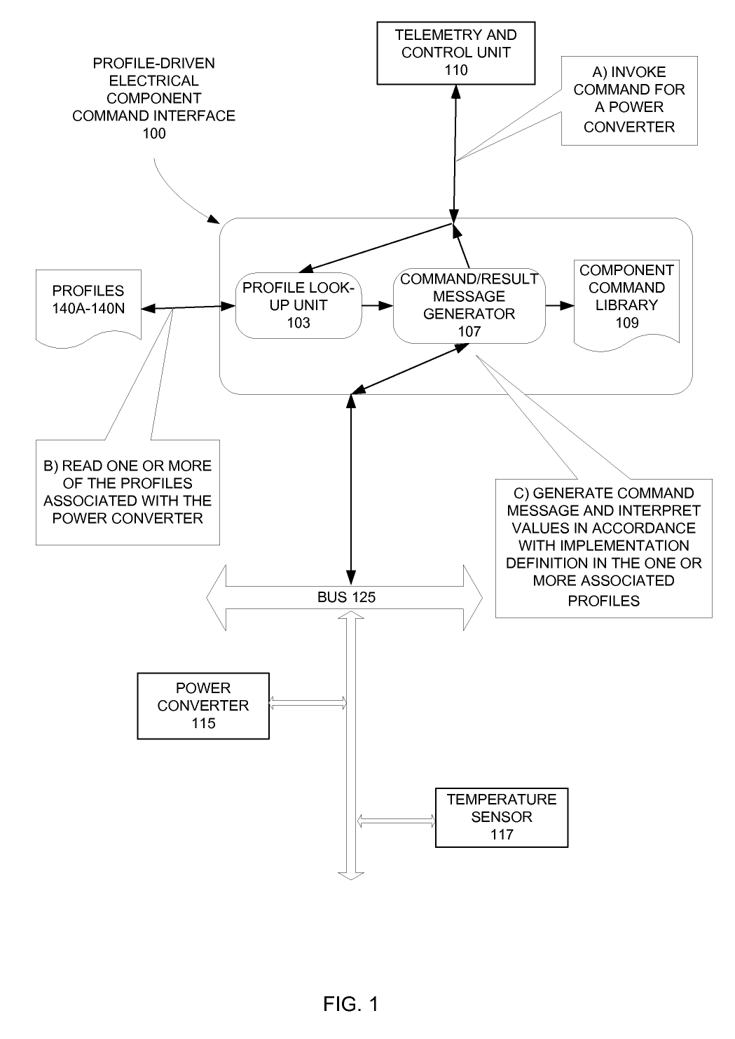

FIG. 1 depicts an example conceptual diagram of a profile-driven electrical component command interface processing electrical component commands. In FIG. 1, a system comprises a telemetry control unit 110, a profile-driven electrical component command interface 100, electrical component profiles 140A-140N, and a bus 125 coupled with example electrical components. FIG. 1 depicts a power converter 115 and a temperature sensor 117 as the example electrical components.

The profile-driven electrical component command interface 100 comprises a profile-look-up unit 103, a command/result message generator 107, and a component command library 109. The profile-driven electrical component command interface 100 fields an invocation of a command that target electrical components. The commands are invoked to perform various types of operations with respect to the electrical components, such as voltage control operations (e.g., read output voltage, set voltage thresholds, etc.), temperature control operation (e.g., read temperature, set temperature thresholds, etc.), fan control operations (e.g., read fan settings, set fan settings, etc.), read electronic component manufacturer information (e.g., read part number, read manufacturer identification number), among others. The profile look-up unit 103 determines if one or more profiles are associated with the targeted electrical component, and loads and/or reads the one or more associated profiles. The command/result message generator 107 generates command messages and result messages. The command/result message generator 107 generates a command message based, at least in part, on the command in the component command library 109 that corresponds to an invoked command. In addition, the message generator 107 generates the command message in accordance with the associated one or more profiles. For instance, one or more values to be written by the invoked command are formatted in accordance with an implementation definition in the one or more associated profiles. The message generator 107 can also generate a result message to supply a result of an invoked command to an invoking entity.

A plurality of stages in FIG. 1 illustrates an example of profile-driven command handling by the profile-driven electrical component command interface 100. At a stage A, the telemetry and control unit 110 invokes a command READ_VOUT for the power converter 115 as presented by the profile-driven electrical component command interface 100. The command invocation may include an indication of a model number and/or manufacturer name for the power converter 115. The indication may be literal or encoded (e.g., a text string, a hash value, a reference to the power converter's profile, etc.). At a stage B, the profile look-up unit 103 accesses a store or memory that hosts the profiles 140A-140N using the power converter indication. After determining the one or more of the profiles 140A-140N associated with the power converter 115, the profile look-up unit 103 loads and/or reads the associated one or more of the profiles 140A-140N, or relevant portions thereof. The profiles 140A-140N can indicate control and monitoring information, such as voltage control parameters, temperature control parameters, addressing information, data formatting information, manufacturer information, etc., associated with the electrical components. For example, an implementation definition for the power converter for READ_VOUT may be as follows:

```
<command id=“READ_VOUT” addressing=“split”>
  <coefficient>
    <slope>4096</slope>
  </coefficient>
  <precision>12</precision>
</command>
```

The profile look-up unit 103 can read an entire profile for the power converter 115 or read the example implementation definition for READ_VOUT from the power converter profile. At a stage C, the command/result message generator 107 generates a command message based upon a READ_VOUT command as provided for in the component command library 109. In the case of the READ_VOUT command, the message generator 107 generates the command message, which is communicated to the power converter 115. Although the command message may be further processed when passing from the profile-driven electrical component command interface 100 to the power converter 115 in the physical layer, such processing is not described to avoid obfuscating the embodiments. When the result of the READ_VOUT command is received from the power converter 115, the message generator 107 interprets the result from the power converter in accordance with the implementation definition for READ_VOUT (i.e., using the slope coefficient and precision as defined in the profile) to provide a result message to the telemetry and control unit 110 with a result that can be understood by the telemetry and control unit 110. Hence, invoking entities (e.g., processes, user level applications, etc.) can invoke a command while being agnostic to the implementation definition of the command for a targeted electrical component. This modularity of electrical component implementation definitions of commands from invokers allows for implementation definitions to be maintained (e.g., adding a new electrical component profile, updating an electrical component profile, removing an electrical component profile, updating a master profile, etc.) independently, thus providing a dynamic and evolving electrical component command interface. Furthermore, the modularity allows a manufacturer to limit visibility of certain information. For instance, if a manufacturer of an electrical component does not want to disclose certain information regarding the electrical component (e.g., register information), then, the manufacturer may create the corresponding profile and store the profile in a memory location specified by the developer instead of having the developer create the corresponding profile.

It should be understood that the conceptual diagram depicted by FIG. 1 illustrates an example, and should not be used to limit embodiments and/or claim scope. For instance, the profiles 140A-140N can be implemented in accordance with a variety of techniques (e.g., records in a database, entries in a hash table, individual files, documents with cross references to other documents to inherit implementation definitions, etc.), and in accordance with a variety of formats (e.g., XML based format, a proprietary format, etc.). In addition, implementation definitions can be shared across different electrical components. Shared implementation definitions can be provided in a separate shared profile, in a parent profile, etc. As another example of variation, the component command library 109 can be implemented separately from the profile-driven electrical component command interface 100. In another example of embodiment diversity, functionality can be implemented in a manner different than depicted. For instance, the profile look-up unit 103 can perform operations to determine a reference (e.g., an index or address) to a profile or relevant portion of the profile, and pass the reference to the message generator 107. Embodiments can also implement functionality to perform operations that look-up a profile and parse the profile for message generation.

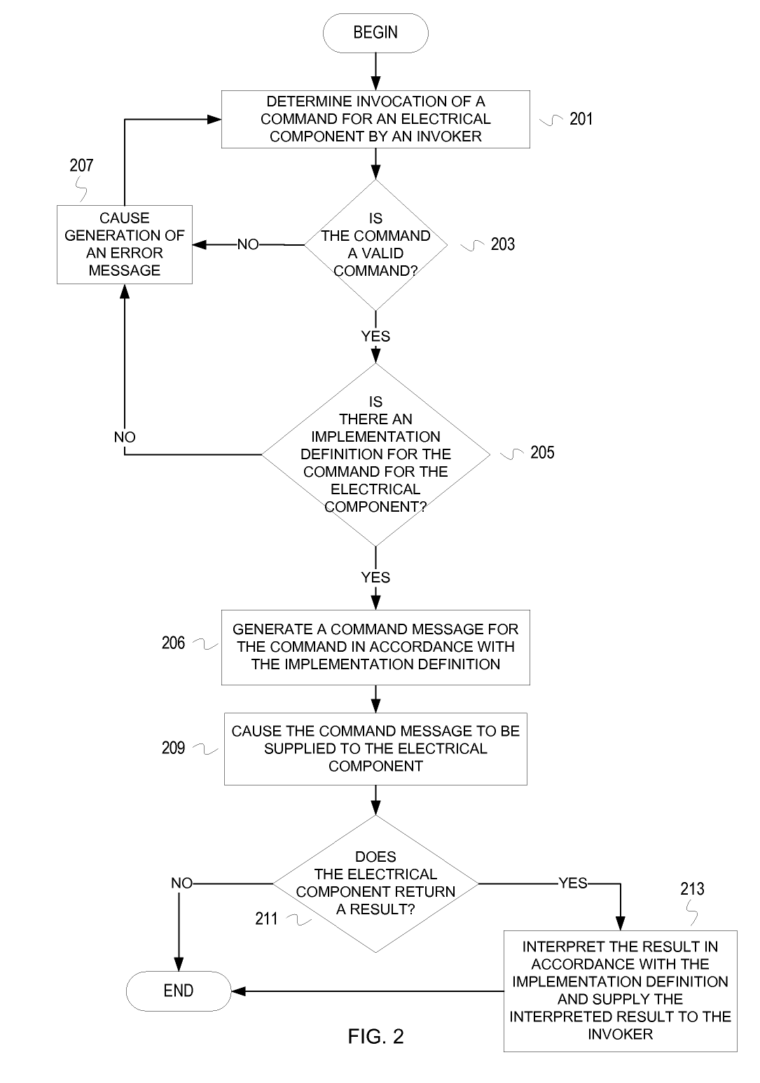

FIG. 2 depicts an example flow diagram of example operations for implementation definition agnostic electrical component command invocations. The flow diagram begins at block 201 where it is determined that an invoker invokes a command for an electrical component. For example, a call is made to a function defined by an application programming interface that implements a profile-driven electrical component command interface.

At block 203, it is determined if the command is a valid command. For instance, a command name passed as a parameter in the command invocation is evaluated against a list of valid commands. As another example, the profile-driven electrical component command interface determines if a command identifier indicated in the command invocation falls within a ranges of values that correspond to valid commands. If the command is not valid, then control flows to block 207. If the command is valid, then control flows to block 205.

At block 205, it is determined if there is an implementation definition for the command for the electrical component. For instance, it is determined if a profile exists for the electrical component targeted by the command, and if the profile indicates an implementation definition for the command. Embodiments can indicate implementation definitions for commands for electrical components differently, and not necessarily organize command implementation definitions in profiles for each electrical component. For instance, a structure can be maintained that is indexed by a command value (e.g., command name, hash of command name, a command number, etc.). Each entry in the structure has another level of indirection using an indicator for the electrical component, which then references the implementation definition for the command. Embodiments can also maintain multiple structures for fast lookup of commonly invoked commands. For example, a structure of implementation definitions for commonly invoked commands can be maintained separately from profiles. The structure could index the implementation definitions by a hash of an electrical component indicator (e.g., serial number and manufacturer name) and an indicator of the command. If an implementation definition for the command for the electrical component cannot be found, then control flows to block 207. If an implementation definition for the command for the electrical component is found, then control flows to block 206.

At block 206, a command message for the invoked command is generated in accordance with the implementation definition.

At block 209, the command message is caused to be supplied to the electrical component.

At block 211, it is determined if the electrical component returns a result from performing the command indicated in the command message. If a result is returned, then control flows to block 213. If a result is not returned, then the flow ends.

At block 213, the result is interpreted in accordance with the implementation definition. The interpreted result is then supplied to the invoker. The operations for reading a profile, generating a command message, and interpreting results may be realized with one or more executable code units (e.g., function, procedure, routine, etc.). For example, a single executable code unit (e.g., machine code, interpreted code, run-time compiled code, byte code, etc.) may call a first executable code unit to read a profile, a second executable code unit to generate the command message sent to the electrical component, and a third executable code unit to interpret a result. Although the operations are already specified with the executable code units, the operations vary dynamically based on the indicated parameters (e.g., location of profiles, name of command, serial number of electrical component, etc.). From block 213, the flow ends.

If the command was determined to be invalid at block 203 or the implementation definition was not found at block 205, then an error message is caused to be generated at block 207.

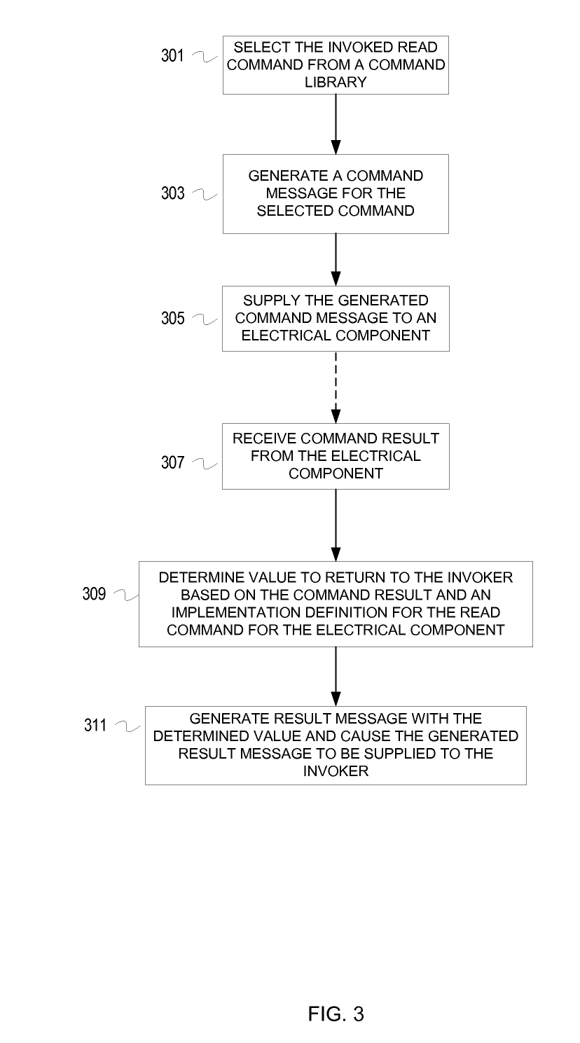

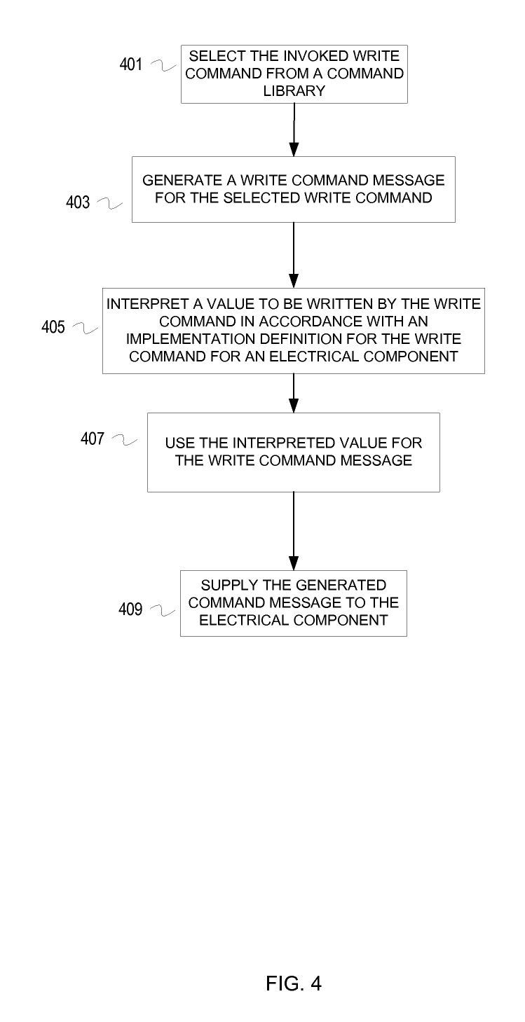

Although FIG. 2 depicts example operations for handling a command invocation, operations can be different for read type commands and write type commands. FIGS. 3 and 4 respectively depict example flow diagrams for read and write type commands.

FIG. 3 depicts a flow diagram of example operations for handling a read command. At block 301, an invoked read command is selected from a command library. For instance, an executable code unit in the command library is selected based on a command name indicated in the command invocation.

At block 303, a command message for the selected command is generated. For instance, a message is generated to instruct an electrical component to perform one or more operations that implement the selected command.

At block 305, the generated command message is caused to be supplied to an electrical component. A dashed line from block 305 to block 307 represents time until a response to the command message is received from the electrical component. At block 307, a command result is received from the electrical component.

At block 309, a value (or values), to be returned to the invoker (e.g., a telemetry and control unit) is determined based on the received command result and an implementation definition for the read command for the electrical component. For instance, the previously determined implementation definition for the read command for the electrical component indicates the following:

$$X = \frac{1}{m} ( Y * {10}^{- R} - b )$$

Where:
X, the calculated, “real world” value (or interpreted result) in the appropriate units (A, V, ° C., etc.);
m, the slope coefficient, is a two byte, two's complement integer;
Y, the result data received from the electrical component, is a two byte, two's complement integer;
b, the offset coefficient, is a two byte, two's complement integer; and
R, the exponent coefficient, is a one byte, two's complement integer.
   The value X is the value to be returned to the invoker. A command interface determines X using the coefficients m, b, and R coefficients, and the command result Y. These coefficients are determined from the implementation definition defined in the associated one or more profiles, although some can be obtained from the electrical component. The command interface may also format X, and return a formatted X to the invoker.

At block 311, the result message with the determined value is generated, and the generated message is caused to be supplied to the invoker.

FIG. 4 depicts a flow diagram of example operations for handling a write command. At block 401, an invoked write command is selected from a command library. For instance, an executable code unit in the command library is selected based on a command name indicated in the write command invocation.

At block 403, a write command message for the selected command is generated. For instance, a message is generated to instruct an electrical component to perform one or more operations that implement the selected write command.

At block 405, a value (or values) to be written (e.g., a voltage threshold value) in accordance with the selected write command is interpreted in accordance with an implementation definition for the write command for an electrical component. To illustrate, the implementation definition for an electrical component may indicate the following:

Y=(mX+b)*10R

Where:

Y, the formatted write data to be sent to the electrical component, is a two byte, two's complement integer;
m, the slope coefficient, is a two byte, two's complement integer;
X, the “real world” value (or the unformatted write data), in the appropriate units (A, V, ° C., etc.);
b, the offset coefficient, is a two byte, two's complement integer; and
R, the exponent coefficient, is a one byte, two's complement integer.
   The value Y is the value to be written by the electrical component. A command interface determines Y using the coefficients m, b, and R, and the value X provided by the invoker. These coefficients are determined from the implementation definition defined in the associated one or more profiles, although some can be obtained from the electrical component.

At block 407, the interpreted value is used in the write command message. For instance, a parameter or field is populated with the determined Y write data.

At block 409, the generated command message is caused to be supplied to an electrical component.

It should be understood that the depicted flow diagrams are examples meant to aid in understanding embodiments and should not be used to limit embodiments or limit scope of the claims. Embodiments may perform additional operations, fewer operations, operations in a different order, operations in parallel, and some operations differently. For instance, in FIG. 2, block 203 may be performed implicitly from block 205 (i.e., it may be assumed that the command is not valid if a profile does not define an implementation for the command). Referring to FIG. 3, operations may be performed at a different time to read the implementation definition. FIG. 3 presumes that the implementation definition has already been determined. Embodiments can perform an additional operation to determine if a command is a read command, and then perform operations to read/load the implementation definition while waiting for a response from the electrical component.

Furthermore, the operations that describe generating a command message should not be used to limit embodiments and/or claim scope. Causing an electrical component to perform operations can be described in various manners based on perspective (e.g., perspective of the telemetry and control unit versus the perspective of the electrical component). Although the same operations are being performed by the electrical component, causing the electrical component to perform those operations can be described as sending a command message to the electrical component, as done in the illustrations. Causing the electrical component to perform those operations can also be described as executing a command, instantiating a command, etc.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language (e.g., Java, Smalltalk, C++, etc.) and conventional procedural programming languages (e.g., “C” programming language). The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

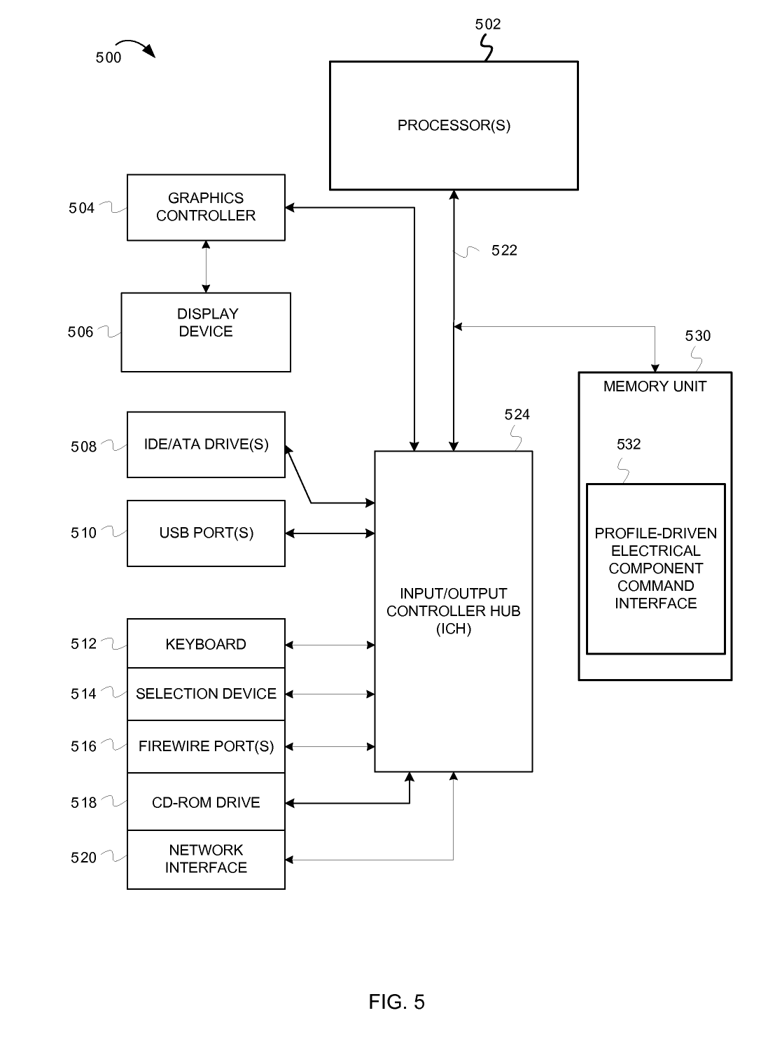

FIG. 5 depicts an example computer system that implements profile-driven electrical component communication code. The computer system 500 includes a processor 502. The processor 502 is connected to an input/output controller hub 524 (ICH), also known as a south bridge, via a bus 522 (e.g., PCI, ISA, PCI-Express, HyperTransport, etc). A memory unit 530 interfaces with the processor 502 and the ICH 524. The main memory unit 530 can include any suitable random access memory (RAM), such as static RAM, dynamic RAM, synchronous dynamic RAM, extended data output RAM, etc. The ICH 524 connects and controls peripheral devices. In FIG. 5, the ICH 524 is connected to IDE/ATA drives 508 (used to connect external storage devices) and to universal serial bus (USB) ports 510. The ICH 524 may also be connected to a keyboard 512, a selection device 614, firewire ports 516 (for use with video equipment), CD-ROM drive 518, and a network interface 520. The ICH 524 can also be connected to a graphics controller 504. The graphics controller is connected to a display device 506 (e.g., monitor).

In one embodiment, the memory unit 530 embodies the profile-driven electrical component command interface 532. The profile-driven electrical component command interface 532 may be implemented in computer system 500 for communicating with a plurality of electrical components, as described above with reference to FIGS. 1-4. In one example, the profile-driven electrical component command interface 532 may communicate with electrical components via the USB ports 510. Although FIG. 5 shows the profile-driven electrical component command interface 532 in memory 530, the profile-driven electrical component command interface need not be embodied in the memory. For example, the profile-driven electrical component command interface 532 may reside on a CD in the CD-ROM drive, on the hard drive, on an ASIC (not shown), etc. In some embodiments, the computer system 500 can include additional devices and/or more than one of each component shown in FIG. 5 (e.g., video cards, audio cards, peripheral devices, etc.). For example, in some instances, the computer system 500 may include multiple processors, multiple cores, multiple external CPU's. In other instances, components may be integrated or subdivided.

While the embodiments are described with reference to various implementations and exploitations, it will be understood that these embodiments are illustrative and that the scope of the inventive subject matter is not limited to them. In general, techniques for profile-driven electrical component communication as described herein may be implemented with facilities consistent with any hardware system or hardware systems. For instance, example systems depicted with a single bus are illustrative and not intended to limit embodiments. A system may include multiple buses, each of which being coupled with one or more electrical components. A system can send a profile-driven electrical component communication to an electrical component on any one of the multiple buses. A system can transmit a profile-driven electrical component communication across multiple buses to a plurality of same or similar electrical components coupled to different ones of the multiple buses. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
detecting invocation of a command by an invoker, wherein the invocation targets an electrical component;
determining that at least a first of a plurality of profiles is associated with the electrical component, wherein the plurality of profiles are associated with respective ones of a plurality of electrical components including the electrical component;
accessing the first profile to determine that the first profile supports the command for the electrical component; and
implementing the command based, at least in part, on the first profile.

2. The method of claim 1, wherein said accessing the first profile to determine that the first profile supports the command for the electrical component comprises accessing the first profile to determine that the first profile indicates an implementation definition for the command for the electrical component.

3. The method of claim 2, wherein said implementation definition indicates at least one of data formatting information, data types, parameters, and coefficients.

4. The method of claim 1, wherein said implementing the command comprises interpreting one or more values in accordance with the first profile.

5. The method of claim 1, wherein said implementing the command comprises generating a command message that indicates the command and causing the generated command message to be supplied to the electrical component.

6. The method of claim 1, wherein the first profile comprises metadata that defines implementation of a power management bus specification for the electrical component.

7. The method of claim 6 further comprising determining that the command is a valid command according to the power management bus specification.

8. The method of claim 1, wherein the first of the plurality of profiles supports the command across a plurality of electrical components that include the electrical component.

9. The method of claim 1, wherein said implementing the command based, at least in part, on the first profile, comprises:
determining one or more parameters from the first profile; and
executing an executable code unit with the determined one or more parameters, wherein the executable code unit causes the electrical component to perform the command.

10. A method comprising:
determining invocation of an electrical component read command by an invoker, wherein the invocation indicates an electrical component;
determining that a first of a plurality of implementation definitions indicates implementation information for the electrical component read command for the electrical component, wherein a second of the plurality of implementation definitions corresponds to a second electrical component;
causing the electrical component to perform the electrical component read command and to generate at least one result value;
receiving the at least one result value from the electrical component;
interpreting the at least one result value for the invoker based, at least in part, on the first of the plurality of implementation definitions; and
supplying the interpreted at least one result value to the invoker.

11. The method of claim 10, wherein the first implementation definition indicates at least one of data formatting information, data types, parameters, and coefficients for the electrical component.

12. The method of claim 10, wherein said causing the electrical component to perform the electrical component read command comprises generating a message that indicates the electrical component read command and causing the generated message to be sent to the electrical component.

13. A method comprising:
determining invocation of an electrical component write command by an invoker, wherein the invocation indicates an electrical component and at least one value to be written by the electrical component;
determining that a first of a plurality of implementation definitions indicates implementation information for the electrical component write command for the electrical component, wherein a second of the plurality of implementation definitions corresponds to a second electrical component;
interpreting the at least one value to be written for the electrical component based, at least in part, on the first of the plurality of implementation definitions; and
causing the electrical component to perform the electrical component write command with the interpreted at least one value to be written.

14. The method of claim 13, wherein the first implementation definition indicates at least one of data formatting information, data types, parameters, and coefficients for the electrical component.

15. The method of claim 13, wherein said causing the electrical component to perform the electrical component write command with the interpreted at least one value to be written comprises generating a message that indicates the interpreted at least one value and indicates the electrical component write command, and causing the message to be sent to the electrical component.

16. An apparatus comprising:
a set of one or more processors;
a bus coupled with the set of one or more processors;
a plurality of electrical components coupled with the bus; and
means for handling agnostic invocation of a power management bus specification command implemented differently across the plurality of electrical components.

17. The apparatus of claim 16 further comprising means for maintaining a plurality of implementation definitions for the plurality of electrical components for a plurality of power management bus specification commands.

18. An apparatus comprising:
a set of one or more processors;
one or more memory coupled with the set of one or more processors;
a bus coupled with the set of one or more processors and the memory;
a plurality of electrical components coupled with the bus; and
an electrical component command interface operable to,
field an invocation of a command that targets a first of the plurality of electrical components from an invoker,
access at least one of a plurality of profiles that support the command for the first electrical component, wherein the plurality of profiles correspond to the plurality of electrical components,
interpret a value to be written by the first electrical component for the first electrical component based, at least in part, on the at least one of the plurality of profiles if the command is a write command, wherein the invocation indicates the value,
interpret a value returned by the first electrical component based, at least in part, on the first of the plurality of profiles if the command is a read command performed by the first electrical component.

19. The apparatus of claim 18, wherein the electrical component command interface is further operable to maintain the plurality of profiles.

20. The apparatus of claim 18, wherein the electrical component command interface is embodied in the memory as a set of instructions.

21. One or more machine-readable media having stored therein a program product, which when executed by a set of one or more processors causes the set of one or more processors to perform operations that comprise:
detecting invocation of a command by an invoker, wherein the invocation targets an electrical component;
determining that at least a first of a plurality of profiles is associated with the electrical component, wherein the plurality of profiles are associated with respective ones of a plurality of electrical components including the electrical component;
accessing the first profile to determine that the first profile supports the command for the electrical component; and
implementing the command based, at least in part, on the first profile.

22. The machine-readable media of claim 21, wherein said operation of accessing the first profile to determine that the first profile supports the command for the electrical component comprises accessing the first profile to determine that the first profile indicates an implementation definition for the command for the electrical component.

23. The machine-readable media of claim 22, wherein said implementation definition indicates at least one of data formatting information, data types, parameters, and coefficients.

24. The machine-readable media of claim 21 wherein said operation of implementing the command comprises interpreting one or more values based, at least in part, on the first profile.

25. The machine-readable media of claim 21 wherein said operation of implementing the command comprises the operations of generating a command message that indicates the command and causing the generated command message to be supplied to the electrical component.
